(19) United States
(12) Patent Application Publication
(10) Pub. No.: US 2022/0113403 A1
(43) Pub. Date: Apr. 14, 2022

(54) METHOD AND DEVICE FOR CONTROLLING VEHICLE, ELECTRONIC EQUIPMENT, AND STORAGE MEDIUM

(71) Applicant: SHANGHAI SENSETIME INTELLIGENT TECHNOLOGY CO., LTD., Shanghai (CN)

(72) Inventors: Jingwei LI, Shanghai (CN); Zhe WANG, Shanghai (CN)

(73) Assignee: SHANGHAI SENSETIME INTELLIGENT TECHNOLOGY CO., LTD., Shanghai (CN)

(21) Appl. No.: 17/645,452

(22) Filed: Dec. 22, 2021

Related U.S. Application Data
(63) Continuation of application No. PCT/CN2021/089379, filed on Apr. 23, 2021.

(30) Foreign Application Priority Data
Jun. 30, 2020 (CN) 202010619835.0

(51) Int. Cl. G01S 13/931; G01S 13/89; G01S 13/08; B60W 30/09; B60W 30/14

(52) U.S. Cl. CPC G01S 13/931; G01S 13/89; G01S 13/08; G01S 2013/9321; B60W 30/146; G01S 2013/9315; B60W 30/09

(57) ABSTRACT

Point cloud data collected by a radar device on a target vehicle can be acquired. Information on an obstacle within a set range from the target vehicle is determined based on the point cloud data. Radar blind zone information of the target vehicle is determined based on beam information of a beam transmitted by the radar device, as well as the information on the obstacle determined. The target vehicle is controlled according to the radar blind zone information of the target vehicle.

### CROSS-REFERENCE TO RELATED APPLICATIONS

The present disclosure is a continuation of International Application No. PCT/CN2021/089379 filed on Apr. 23, 2021, which claims priority to Chinese Patent Application No. 202010619835.0 filed on Jun. 30, 2020. The disclosures of the above-referenced applications are hereby incorporated by reference in their entirety.

### BACKGROUND

Radar is advantageous in that it is of high resolution, high ranging precision, good detectability, etc., and is the most important sensor in a self-driving vehicle.

Generally, an obstacle may be detected based on radar on a vehicle, thus determining a relation between locations of the obstacle and the vehicle.

### SUMMARY

The present disclosure relates to the field of radar, and more particularly, to a method and device for controlling a vehicle, electronic equipment, and storage medium.

Embodiments of the present disclosure provide at least a solution for controlling a vehicle.

According to a first aspect, embodiments of the present disclosure provide a method for controlling a vehicle, including: acquiring point cloud data collected by a radar device on a target vehicle; determining, based on the point cloud data, information on an obstacle within a set range from the target vehicle; determining radar blind zone information of the target vehicle based on beam information of a beam transmitted by the radar device, as well as the information on the obstacle determined; and controlling the target vehicle according to the radar blind zone information of the target vehicle.

In embodiments of the present disclosure, in the travel process of the target vehicle, the radar blind zone information is always determined based on the information on the obstacle within the set range from the target vehicle as well as the beam information of the beam transmitted by the radar device. In this way, in the travel process of the target vehicle, the radar blind zone information for the target vehicle in the travel process may be determined constantly through the changing information on the obstacle. Accordingly, the travel process of the target vehicle may be controlled effectively based on this, thereby reducing probability of occurrence of collision to the target vehicle, improving safety.

According to an aspect, embodiments of the present disclosure provide a device for controlling a vehicle, including a data acquiring part, a first determining part, a second determining part, and a vehicle controlling part.

The data acquiring part is configured to acquire point cloud data collected by a radar device on a target vehicle.

The first determining part is configured to determine, based on the point cloud data, information on an obstacle within a set range from the target vehicle.

The second determining part is configured to determine radar blind zone information of the target vehicle based on beam information of a beam transmitted by the radar device, as well as the information on the obstacle determined.

The vehicle controlling part is configured to control the target vehicle according to the radar blind zone information of the target vehicle.

According to an aspect, embodiments of the present disclosure provide electronic equipment, including a processor, a storage, and a bus. The storage stores machine-readable instructions executable by the processor. The processor and the storage communicating via the bus when the electronic equipment operates. When executed by the processor, the machine-readable instructions perform the steps of the method of the first aspect.

According to an aspect, embodiments of the present disclosure provide a non-transitory computer-readable storage medium, having stored thereon a computer program which, when executed by a processor, implements the steps of the method of the first aspect.

According to an aspect, embodiments of the present disclosure provide a computer program, including a computer-readable code which, when run on computer equipment, allows a processor in the computer equipment to implement the steps of the method of the first aspect.

To clearly show the purpose, characteristics, and beneficial effects of the present disclosure, detailed description is made below with reference to the drawings and embodiments.

### BRIEF DESCRIPTION OF THE DRAWINGS

Drawings to be used in embodiments of the present disclosure are introduced below briefly for clearer illustration of a technical solution of the embodiments of the present disclosure. Drawings here are incorporated in and constitute part of the specification, illustrate embodiments according to the present disclosure, and together with the specification, serve to explain a technical solution of the present disclosure. It should be understood that the drawings below illustrate just some embodiments of the present disclosure, and therefore shall not be deemed as limiting the scope. A person having ordinary skill in the art may acquire other drawings according to the drawings here without creative effort.

FIG. 1 is a flowchart of a method for controlling a vehicle according to an embodiment of the present disclosure.

FIG. 2 is a diagram of a beam distribution according to an embodiment of the present disclosure.

FIG. 3A is a flowchart of determining information on an obstacle according to an embodiment of the present disclosure.

FIG. 3B is a flowchart of determining radar blind zone information according to an embodiment of the present disclosure.

FIG. 4 is a flowchart of generating a present radar blind zone grid map according to an embodiment of the present disclosure.

FIG. 5A is a diagram of a light path according to an embodiment of the present disclosure.

FIG. 5B illustrates a diagram of a mesh index sequence corresponding to a light path according to an embodiment of the present disclosure.

FIG. 6A is a diagram of a vehicle travel scene according to an embodiment of the present disclosure.

FIG. 6B is a grid map according to an embodiment of the present disclosure.

FIG. 6C is a present obstacle grid map according to an embodiment of the present disclosure.

FIG. 6D is a present radar blind zone grid map according to an embodiment of the present disclosure.

FIG. 6E is a diagram of a light path obstructed by an obstacle according to an embodiment of the present disclosure.

FIG. 7 is a flowchart of determining a radar blind zone according to an embodiment of the present disclosure.

FIG. 8 is a flowchart of a method for controlling vehicle travel according to an embodiment of the present disclosure.

FIG. 9 is a diagram of a structure of a device for controlling a vehicle according to an embodiment of the present disclosure.

FIG. 10 is a diagram of a structure of electronic equipment according to an embodiment of the present disclosure.

### DETAILED DESCRIPTION

To make an object, a technical solution, and beneficial effects of embodiments of the present disclosure clearer, clear complete description of the technical solution of embodiments of the present disclosure is given below with reference to the drawings of embodiments of the present disclosure. Clearly, embodiments illustrated are just some, instead of all, embodiments according to the present disclosure. A component of embodiments of the present disclosure illustrated in the drawings here generally may be arranged and designed in various different configurations. Accordingly, the following elaboration of embodiments of the present disclosure provided in the drawings is not intended to limit the scope of the present disclosure as claimed, and represents just selected embodiments of the present disclosure. Based on embodiments of the present disclosure, a person having ordinary skill in the art may acquire another embodiment without creative effort. Any such embodiment falls within the scope of the present disclosure.

It should be noted that similar numerals and letters denote similar items in the drawings. Therefore, once an item is defined in a drawing, no further definition or explanation for the item is needed in a subsequent drawing.

Due to obstruction by the obstacle and a vertical angular resolution of a radar per se, there may be a radar blind zone in point cloud data collected by the radar. A reasonable estimation of the blind zone is of great importance to vehicle control.

More specifically, in the field of self-driving, an obstacle is generally detected by a radar device. Therefore, during driving, it is determined how to travel to avoid a detected obstacle based on the location of the obstacle. However, while a vehicle travels, due to obstruction of a radar device by an obstacle and a vertical angular resolution of the radar per se, there may be a radar blind zone in point cloud data collected by the radar. A technical problem to be discussed in the present disclosure is how to determine a radar blind zone, and further control vehicle travel based on the radar blind zone. The radar includes laser radar, millimeter wave radar, ultrasonic radar, etc.

Based on the research, embodiments of the present disclosure provide a method for controlling a vehicle, where point cloud data collected by a radar device are acquired while a target vehicle travels. Information on an obstacle within a set range from the target vehicle, such as information on a height, a width, a depth, etc., of the obstacle, may be determined based on the point cloud data. Then, radar blind zone information for the target vehicle is determined based on the information on the obstacle determined, as well as beam information of a radio wave transmitted by the radar device. With embodiments of the present disclosure, in the travel process of the target vehicle, the radar blind zone information is always determined based on the information on the obstacle within the set range from the target vehicle as well as the beam information of the radio wave transmitted by the radar device. In this way, in the travel process of the target vehicle, the radar blind zone information for the target vehicle in the travel process may be determined any time when there is a change in the information on the obstacle with respect to the target vehicle. Accordingly, the travel process of the target vehicle may be controlled effectively based on this, reducing probability of occurrence of collision to the target vehicle, improving safety.

To facilitate understanding the embodiment, first, a method for controlling a vehicle disclosed in embodiments of the present disclosure is described in detail. Generally, the method for controlling a vehicle provided in embodiments of the present disclosure is implemented by computer equipment with certain computing capability. The computer equipment includes, for example, terminal equipment or a server or other processing equipment. Terminal equipment may be User Equipment (UE), mobile equipment, a user terminal, computing equipment, onboard equipment, etc. In some possible implementations, the method for controlling a vehicle may be implemented by a processor by calling computer-readable instructions stored in memory.

With embodiments of the present disclosure, a vehicle control mode is described in detail taking an execution subject of onboard equipment as an example.

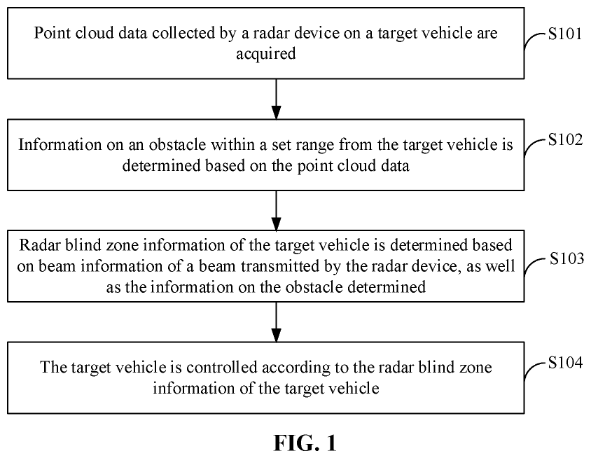

FIG. 1 is a flowchart of a method for controlling a vehicle according to an embodiment of the present disclosure. The method includes steps S101˜S104.

In S101, point cloud data collected by a radar device on a target vehicle are acquired.

The radar device may be provided at a set location of the target vehicle, continuously collect point cloud data in the travel process of the target vehicle, and transmit the collected point cloud data to onboard equipment.

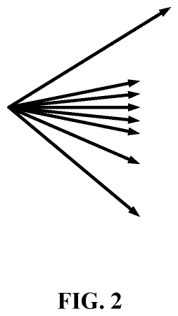

For example, the radar device may be a 64-beam laser radar device. That is, a laser transmitter of the laser radar device includes 64 laser diodes, and may transmit 64 coplanar laser beams. During application, by adjusting a mounting location and a mounting angle of mounting the laser radar device, as well as adjusting an arrangement angle of arranging the laser transmitter, a plane in which the 64 laser beams are located may be made perpendicular to the ground, so as to detect obstacles at different heights in a set direction. As the laser transmitter rotates mechanically, the laser transmitter may collect location information of point cloud points acquired within a range of 360 degrees of rotation of the laser transmitter at set time intervals, acquiring the point cloud data. As shown in FIG. 2, the laser transmitter transmits eight laser beams in a plane perpendicular to the ground.

In S102, information on an obstacle within a set range from the target vehicle is determined based on the point cloud data.

After the mounting location and the mounting angle of the radar device on the target vehicle as well as the arrangement angle of the radar transmitter have been adjusted, a scan zone scanned by the radar device may be determined. Thus, an obstacle within a set range from the target vehicle may be scanned. Thus, information on the locations of points constituting the contour of the obstacle in a set coordinate system may be acquired and taken as the information on the obstacle. Here, the set coordinate system may be set as needed. For example, a coordinate system centered on the target vehicle may be set as a vehicle coordinate system, etc., to which embodiments of the present disclosure are not limited. In embodiments of the present disclosure, in this way, information on an obstacle within a set range from the target vehicle may be acquired based on the point cloud data.

In S103, radar blind zone information of the target vehicle is determined based on beam information of a beam transmitted by the radar device, as well as the information on the obstacle determined.

The beam information may include a number of beams of radio waves transmitted by the radar device at various rotational angles and beam heights from the ground. In some embodiments, the beam information may be represented by a pre-established beam height map. For example, a grid map under a bird's eye view covering the target vehicle and a ground surface zone within a set range from the target vehicle may be pre-constructed. Then, a beam height map corresponding to the grid map may be generated based on the beam information of the beam transmitted by the radar device. The beam height map includes three dimensions, with the first two dimensions representing a row location and a column location of a mesh in the beam height map, and the third dimension representing the number of beams covered by the mesh. In addition, the height of each beam covered by the mesh in the mesh may be recorded in the mesh.

The beam number corresponding to a mesh may refer to, of any beam transmitted by the radar device, a number of beams entering the mesh, as determined according to just the mounting location and the mounting angle of the radar device as well as the arrangement angle of the radar transmitter, without considering any obstacle in the mesh. Illustratively, by moving a beam entering the mesh to an intersection where it intersects a straight line passing through the center of the mesh and perpendicular to a grid plane, the distance between the intersection and the center of the mesh may be taken as the beam height of the beam at the mesh.

In embodiments of the present disclosure, a beam height map may be determined without considering any obstacle corresponding to the mesh. That is, a beam height map including the most complete beams may be acquired. When radar blind zone information is determined subsequently, the beam height map may provide a raw beam corresponding to each mesh. In embodiments of the present disclosure, a beam height map may be generated in a mode as follows.

(1) A ground surface grid map of the ground surface within a set range from the target vehicle may be constructed in advance. The ground surface grid map may include multiple meshes.

(2) An internal parameter of the radar device and an external parameter of the radar device may be adjusted. The internal parameter may include a preset angle of the radio wave transmitter in the vertical direction. The external reference may include the mounting location and the mounting angle of mounting the radio wave transmitter on the target vehicle. Then, multiple meshes through which a beam transmitted by the radar device passes, as well as the beam height of the beam at each mesh as the beam passes through the each mesh, may be computed based on the adjusted internal parameter and the adjusted external parameter.

(3) A beam height map may be acquired by recording and storing the beam number and beam heights corresponding to each mesh.

In S104, the target vehicle may be controlled according to the radar blind zone information of the target vehicle.

For example, radar blind zone information for different types of target objects may differ. For example, more beams are needed to scan contour information of a large target object. In this case, at least one of a mesh corresponding to fewer beams or a mesh corresponding to a lowest beam height less than the height of the target object may be construed as a blind zone for a target object of this type. For example, if the target object is a target object of a height of 1.8 m, three beams are needed to scan the target object, and the height of each beam to the ground does not exceed 1.8 m. In case the lowest beam height corresponding to any mesh in a zone is greater than 1.8 m and/or there are less than 3 effective beams corresponding to the any mesh, the zone may be a blind zone for the target object of 1.8 m in the travel process of the target vehicle.

Two beams are needed to scan a target object of a small size, such as a target object of a height of 1 m, with the height of each beam to the ground not exceeding 1 m. In case the lowest beam height corresponding to any mesh in a zone is greater than 1 m and/or there are less than 2 effective beams corresponding to the any mesh, the zone may be a blind zone for the target object of 1 m in the travel process of the target vehicle.

In S101˜S104, in the travel process of the target vehicle, the radar blind zone information is always determined based on the information on the obstacle within the set range from the target vehicle as well as the beam information of the beam transmitted by the radar device. In this way, in the travel process of the target vehicle, the radar blind zone information for the target vehicle in the travel process may be determined constantly through the changing information on the obstacle. Accordingly, the travel process of the target vehicle may be controlled effectively based on this, thereby reducing probability of occurrence of collision to the target vehicle, improving safety.

The S101˜S104 are described below with specific embodiments.

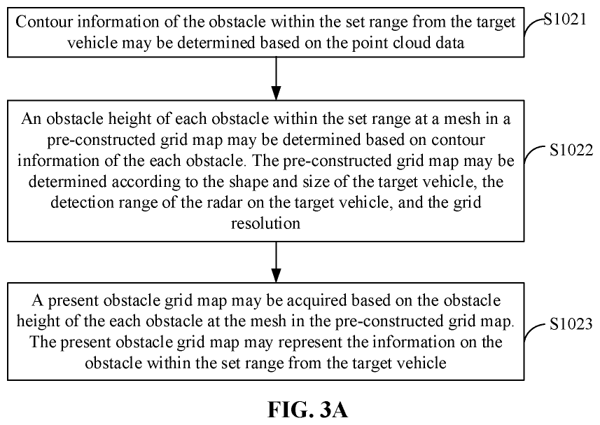

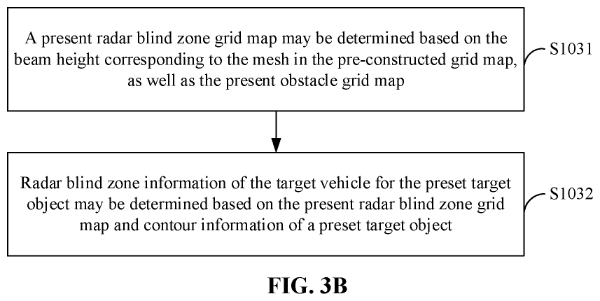

In S102, as shown in FIG. 3A, the information on the obstacle within the set range from the target vehicle may be determined based on the point cloud data via S1021˜S1023 as follows.

In S1021, contour information of the obstacle within the set range from the target vehicle may be determined based on the point cloud data.

For example, the point cloud data may include coordinates of point cloud points in the vehicle coordinate system. Contour information of the obstacle in the vehicle coordinate system, such as the contour of a pedestrian, the contour of a vehicle, or the contour of a building, within the set range from the target vehicle may be acquired based on coordinates of point cloud points in the point cloud data.

For example, in one implementation, the contour information of an obstacle may be represented by the size of a 3D bounding box corresponding to the obstacle. The 3D bounding box may be a 3D rectangular box or a 3D polygonal detection box formed by a 3D convex polygon. A 3D rectangular box and a 3D convex polygon may be determined as briefly described as follows.

For example, a rectangular detection frame of an obstacle in a ground zone corresponding to the obstacle is determined based on point cloud data corresponding to the obstacle. Then, the rectangular detection frame of the obstacle is stretched along a direction perpendicular to the rectangular detection frame or a direction perpendicular to the ground, until the obstacle height is reached, acquiring the 3D rectangular frame.

For example, an envelope polygonal detection frame of an obstacle in a ground zone corresponding to the obstacle is determined based on point cloud data corresponding to the obstacle. Then, the polygonal detection frame of the obstacle is stretched along a direction perpendicular to the polygonal detection frame or a direction perpendicular to the ground, until the obstacle height is reached, acquiring the 3D convex polygon.

In S1022, an obstacle height of each obstacle within the set range at a mesh in a pre-constructed grid map may be determined based on contour information of the each obstacle. The pre-constructed grid map may be determined according to the shape and size of the target vehicle, the detection range of the radar on the target vehicle, and the grid resolution.

For example, a mesh occupied by an obstacle in the pre-constructed grid map may be determined through a coordinate range corresponding to a bottom zone of a 3D bounding box corresponding to the obstacle in the vehicle coordinate system. For example, a grid zone occupied by the obstacle in the grid map includes six meshes. Then, the obstacle height of the obstacle at each mesh in the pre-constructed grid map may be determined based on the height of the 3D bounding box corresponding to the obstacle.

In embodiments of the present disclosure, the radar device may establish an obstacle list for an obstacle detected within a set range. In this way, the radar device may determine an obstacle height of each obstacle in the obstacle list at a respective mesh in the pre-constructed grid map.

In embodiments of the present disclosure, the radar device may construct a grid map for a projection zone acquired by projecting, on the ground, a detection range scanned by the radar on the target vehicle. A projection zone formed when the radar is mounted on the target vehicle does not include the projection of the target vehicle on the ground. The size and shape of the grid map may be determined by the projection zone. The number of meshes included in the grid map may be determined by a pre-set grid resolution. The grid resolution may represent a reciprocal of a length of a side of one mesh, as well as a number of meshes included in a unit area.

With the grid resolution determined, the number of meshes included in the grid map may be determined. The higher the grid resolution is, the smaller the size of one mesh, the smaller the size corresponding to an obstacle at an associated mesh, therefore the closer the upper surface corresponding to the obstacle at a respective mesh is to a plane, and thus the more accurate an obstacle height determined at the respective mesh. However, the more meshes there are, the lower the efficiency will be. A balance between accuracy and efficiency may be achieved according to big data, thereby selecting a reasonable grid resolution.

In S1023, a present obstacle grid map may be acquired based on the obstacle height of the each obstacle at the mesh in the pre-constructed grid map. The present obstacle grid map may represent the information on the obstacle within the set range from the target vehicle.

For example, the present obstacle grid map may be acquired by labeling each mesh in the pre-constructed grid map with the obstacle height corresponding to the each mesh based on the obstacle height of the each obstacle at the mesh in the pre-constructed grid map.

In embodiments of the present disclosure, contour information of an obstacle is determined by point cloud data. Then, an obstacle grid map representing the location and height of the obstacle is generated through the contour information of the obstacle, allowing to acquire information on an obstacle within a set range from the target vehicle, facilitating subsequent determination of an effective beam height and an effective beam number corresponding to each mesh based on the obstacle grid map and the beam information, preparing for determination of radar blind zone information.

In some embodiments, the beam information includes a beam height of the beam transmitted by the radar device within the mesh in the pre-constructed grid map. The beam height within a mesh may be acquired from the beam height map aforementioned. In S103, as shown in FIG. 3B, the radar blind zone information of the target vehicle may be determined based on the beam information of the beam transmitted by the radar device, as well as the information on the obstacle determined, via S1031˜S1032 as follows.

In S1031, a present radar blind zone grid map may be determined based on the beam height corresponding to the mesh in the pre-constructed grid map, as well as the present obstacle grid map.

A beam height corresponding to each mesh in the pre-constructed grid map may be acquired from the beam height map constructed above. Then, the present radar blind zone grid map may be acquired by determining the lowest beam height and the number of effective beams corresponding to each mesh based on the beam height corresponding to the mesh and the obstacle height corresponding to the mesh in the present obstacle grid map.

The number of effective beams corresponding to a mesh may refer to the number of beams that may enter the mesh. For example, if there is an obstacle at a mesh, an effective beam corresponding to the mesh is a beam with a beam height at the mesh greater than the height of the obstacle in the mesh. The lowest beam height corresponding to a mesh may refer to the height of a beam with the lowest height of the effective beams corresponding to the mesh.

In S1032, radar blind zone information of the target vehicle for the preset target object may be determined based on the present radar blind zone grid map and contour information of a preset target object.

For example, the preset target object may be determined in connection with an scene of application of the target vehicle. In case the target vehicle is an unmanned vehicle that mainly travels within a set track zone for cargo transportation, with a significant probability of cargo occurrence and a trivial probability of pedestrian occurrence in the set track zone, the preset target object may refer to but a cargo.

For example, in case the target vehicle mainly travels in a residential area with many children, the preset target object may be a child.

In some embodiments, the radar blind zone information of the target vehicle for the preset target object may be determined based on the present radar blind zone grid map and the contour information of the preset target object as follows. It may be determined, using the number of effective beams and the lowest beam height corresponding to each mesh in the present radar blind zone grid map, as well as the maximal beam height and the number of effective beams in case the preset target object can be scanned, that a mesh is a radar blind zone with respect to the preset target object in case the lowest beam height corresponding to the mesh is greater than the maximal beam height in case the preset target object can be scanned. Refer to the introduction above for details, which are not repeated here.

In embodiments of the present disclosure, the number of effective beams and the lowest beam height corresponding to each mesh may be quickly determined through the beam height corresponding to the mesh in the pre-constructed grid map and the obstacle height corresponding to the mesh in the present obstacle grid map, so that the present radar blind zone grid map of the target vehicle may be acquired. Then, the radar blind zone information may be determined quickly based on the contour information of the preset target object, allowing subsequent control of the travel process of the target vehicle based on the radar blind zone information.

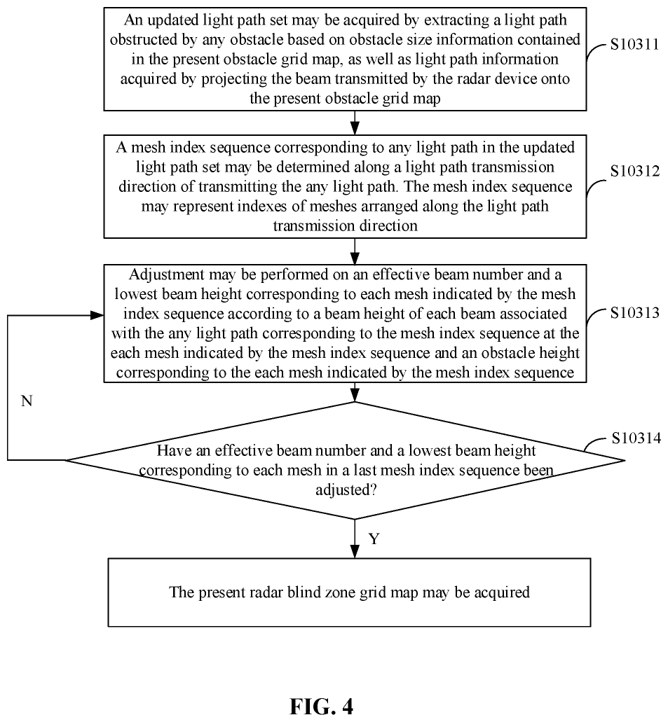

In S1031, as shown in FIG. 4, the present radar blind zone grid map may be determined based on the beam height corresponding to the mesh in the pre-constructed grid map, as well as the present obstacle grid map, via S10311˜S10314 as follows.

In S10311, an updated light path set may be acquired by extracting a light path obstructed by any obstacle based on obstacle size information contained in the present obstacle grid map, as well as light path information acquired by projecting the beam transmitted by the radar device onto the present obstacle grid map.

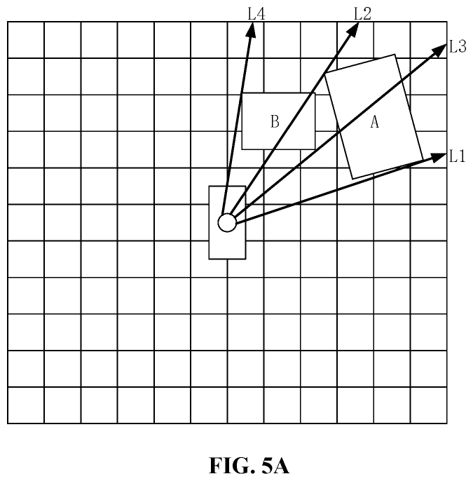

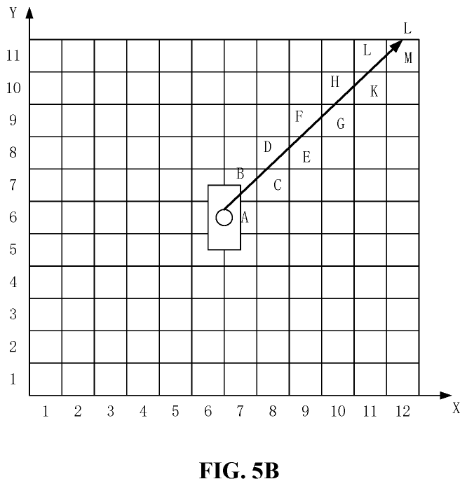

The information on the size of an obstacle mainly includes the projection size of the obstacle in the present obstacle grid map, as shown in FIG. 5A, which is the present obstacle grid map including two obstacles (respectively recorded as the obstacle A and the obstacle B). It may be seen that the two light paths forming the maximal angle obstructed by the obstacle A are recorded as L1 and L2, respectively. The two light paths forming the maximal angle obstructed by the obstacle B are recorded as L3 and L4, respectively. Then, here, all light paths located within the angle formed by L1 and L2 may be extracted, and all light paths located within the angle formed by L3 and L4 may be extracted. It may be seen from FIG. 5A that some light paths located within the angle formed by L1 and L2 overlap some light paths located within the angle formed by L3 and L4. Here, two overlapping light paths may be extracted just once.

Each light path corresponds to beams of one rotation angle. Taking a 64-bit radar device as an example, each light path corresponds to 64 beams of one rotation angle. Assume that the angle formed by L1 and L2 includes 10 light paths, the angle formed by L3 and L4 includes 5 light paths, and assume that the angle formed by L1 and L2 and the angle formed by L3 and L4 overlap each other. For example, there are two light paths in the angle formed by L2 and L3 as shown in FIG. 5A, and the two light paths coincide each other. Just one of the two coinciding light paths may be extracted. Thus, an updated light path set acquired here may include 14 light paths.

In S10312, a mesh index sequence corresponding to any light path in the updated light path set may be determined along a light path transmission direction of transmitting the any light path. The mesh index sequence may represent indexes of meshes arranged along the light path transmission direction.

For example, without considering any obstacle, if any light path in the updated light path set passes through 100 meshes in the present grid map, the mesh index sequence corresponding to the light path is indexes of the 100 meshes arranged along the light path transmission direction of the light path.

For ease of understanding, refer to FIG. 5B. The location of a mesh of the grid map on the X-axis may indicate the column location of the mesh in the grid map. The location of a mesh of the grid map on the Y-axis may indicate the row location of the mesh in the grid map. A light path L passes through meshes A˜M along the transmission direction. In the grid map, the column location of the mesh A is 7, and the row location of the mesh A is 6. The index corresponding to the mesh A may be represented by (7, 6). The index of any other mesh through which the light path L passes may be determined likewise. Here, the sequence of mesh indexes corresponding to the light path L may be determined in the order of the meshes A˜M.

In S10313, an effective beam number and a lowest beam height corresponding to each mesh indicated by the mesh index sequence may be adjusted according to a beam height of each beam associated with the any light path corresponding to the mesh index sequence at the each mesh indicated by the mesh index sequence and an obstacle height corresponding to the each mesh indicated by the mesh index sequence.

In S10314, it may be determined whether an effective beam number and a lowest beam height corresponding to each mesh in a last mesh index sequence have been adjusted. If the effective beam number and the lowest beam height corresponding to the each mesh in the last mesh index sequence have not been adjusted, S10313 may be implemented once more. If the effective beam number and the lowest beam height corresponding to the each mesh in the last mesh index sequence have been adjusted, the present radar blind zone grid map may be acquired.

First, each beam associated with any light path corresponding to a mesh index sequence may be acquired. In adjusting the lowest beam height and the effective beam number corresponding to a mesh corresponding to the first index in the mesh index sequence, all beams associated with the light path may be sorted in order of ascending beam heights, and then, starting from the lowest beam height, the beam heights may be compared to the obstacle height corresponding to the mesh one by one; a beam with a beam height greater than or equal to the obstacle height may be taken as an effective beam corresponding to the mesh, and a beam with a beam height less than the obstacle height may be taken as an ineffective beam corresponding to the mesh. An ineffective beam is a beam obstructed by the obstacle. In this way, the lowest beam height and the effective beam number corresponding to the mesh may be adjusted. Once the adjustment completes, a mesh identified by the next index of the mesh index may continue to be adjusted, until adjustment has been performed for each mesh indicated by the mesh index sequence. Then, after the lowest beam height and the effective beam number corresponding to each mesh in another mesh index sequence have subsequently been adjusted, the present radar blind zone grid map may be acquired.

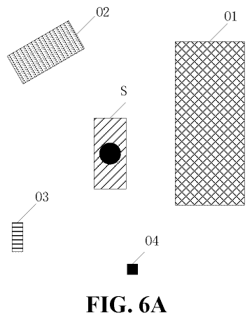

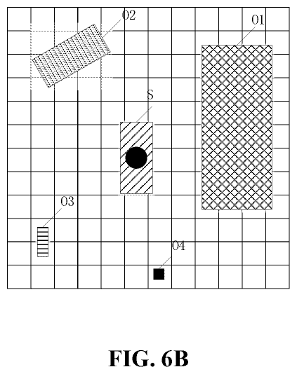

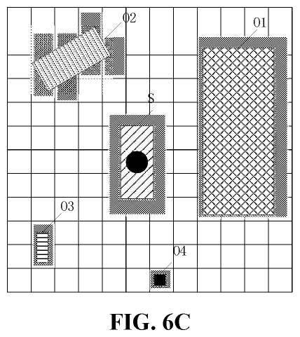

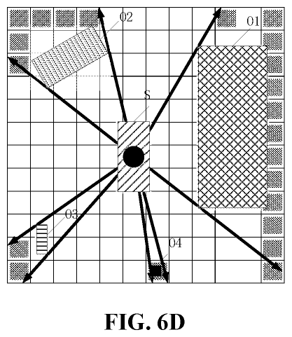

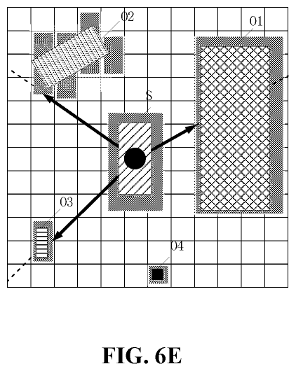

Illustratively, FIG. 6A shows the target vehicle S and four obstacles O1-O4. FIG. 6B may be acquired by placing the target vehicle S and the four obstacles in a grid map. It may be seen that each obstacle occupies a corresponding mesh in the grid map. After the radar device of the target vehicle S has performed 360° scan, a present obstacle grid map may be acquired, as shown in FIG. 6C. The present obstacle grid map includes the target vehicle S and meshes occupied respectively by the four obstacles, and an obstacle height in each mesh. Then, the radar device may determine the present radar blind zone grid map based on the obstacle grid map and the beam height of each mesh. As shown in FIG. 6D, the radar device is to traverse two light paths of a maximal angle obstructed by each of the four obstacles, thereby acquiring an updated set of obstacle-obstructed light paths. Then, the present radar blind zone grid map may be determined according to the updated light path set. Refer to FIG. 6E. FIG. 6E illustratively shows light paths obstructed by obstacles O1, O2, and O3.

In embodiments of the present disclosure, it is proposed to sequentially perform adjustment for meshes indicated by a mesh index sequence corresponding to each light path, and the adjustment may be done on each mesh sequentially according to the beam transmission direction, thereby providing a mode of sequential update of the lowest beam height and the effective beam number corresponding to each mesh.

In some embodiments, in S10313, adjustment may be performed on the effective beam number and the lowest beam height corresponding to each mesh indicated by a mesh index sequence, as follows.

(1) A beam height of the each beam corresponding to the mesh index sequence in a present mesh in the mesh index sequence may be compared successively to an obstacle height corresponding to the present mesh. A beam corresponding to the mesh index sequence with a beam height in the present mesh higher than the obstacle height corresponding to the present mesh may be taken as an effective beam corresponding to the present mesh.

The mesh index sequence may be any one of multiple mesh index sequences. For example, before performing adjustment for an effective beam corresponding to a present mesh in a mesh index sequence, a beam that can enter the present mesh is acquired. The beam that can enter the present mesh may be an effective beam of a previous mesh in the mesh index sequence located before the present mesh. It is not needed to perform comparison for every beam associated with a light path corresponding to the mesh index sequence, thereby improving a speed of adjustment.

(2) A lowest beam height corresponding to the present mesh may be adjusted based on the beam height of the effective beam corresponding to the present mesh. An effective beam number corresponding to the present mesh may be adjusted based on a number of effective beams corresponding to the present mesh of any beam corresponding to the mesh index sequence.

Given that the present mesh may correspond to not just a unique mesh index sequence, in case the present mesh corresponds to multiple mesh index sequences, when adjusting the lowest beam height and the effective beam number corresponding to the present mesh, given that the lowest beam height and the effective beam number corresponding to the present mesh have been saved after the adjustment performed for the present mesh, adjustment may be performed again for the present mesh by adjusting the stored lowest beam height corresponding to the present mesh based on the beam height of the effective beam of the present mesh determined in the previous adjustment. In addition, in any beam corresponding to the mesh index sequence, the saved effective beam number corresponding to the present mesh may be adjusted likewise based on the effective beam number corresponding to the present mesh.

For example, among the beam heights of the effective beams corresponding to the present mesh and the stored lowest beam height corresponding to the present mesh, the lowest beam height is taken as the lowest beam height corresponding to the present mesh after the present adjustment has been performed for the present mesh. The maximal effective beam number corresponding to the present mesh may be acquired based on the effective beam number corresponding to the present mesh acquired by the present adjustment as well as the stored effective beam number corresponding to the present mesh, and taken as the effective beam number corresponding to the present mesh after the present adjustment has been performed for the present mesh.

For example, in case the present mesh corresponds to just one mesh index sequence, the stored lowest beam height corresponding to the present mesh may be a preset large value. In addition, the stored effective beam number corresponding to the present mesh may be a preset small value, such as zero.

(3) The effective beam number and the lowest beam height corresponding to the each mesh indicated by the mesh index sequence after the adjustment may be acquired by taking the effective beam corresponding to the present mesh as a beam entering a next mesh in the mesh index sequence, taking the next mesh as the present mesh, and continuing to adjust the effective beam number and the lowest beam height corresponding to the present mesh, until the beam height of the each beam entering the present mesh is lower than the obstacle height corresponding to the present mesh.

After an effective beam corresponding to the present mesh has been acquired, the effective beam may be taken as a beam that may enter the next mesh in the mesh index sequence. In this way, the lowest beam height and the effective beam number corresponding to the next mesh may be adjusted without having to consider an ineffective beam corresponding to the present mesh, thereby increasing the speed of adjusting the lowest beam height and the effective beam number corresponding to a subsequent mesh.

When the beam height of each beam entering the present mesh is lower than the obstacle height corresponding to the present mesh, it means that the present mesh has no effective beam. In this case, no light in the any beam associated with the light path enters the next mesh in the mesh index sequence. Therefore, there is no need to continue to adjust the lowest beam height and the effective beam number corresponding to a subsequent mesh. The lowest beam height corresponding to the present mesh may be given a large value, and the effective beam number may be given the value 0.

In embodiments of the present disclosure, when adjusting the lowest beam height and the effective beam number corresponding to each mesh indicated by a mesh index sequence, any ineffective beam corresponding to the previous mesh of the mesh is filtered out, thereby increasing the adjustment speed.

In another implementation of embodiments of the present disclosure, the lowest beam height and the effective beam number corresponding to each mesh indicated by each mesh index sequence may also be likewise adjusted at the same time, to finally acquire the present radar blind zone grid map. In case of simultaneous adjustment, adjustment may be performed for each mesh according to the light path transmission direction.

In particular, when adjusting the lowest beam height and the effective beam number corresponding to a mesh including multiple light paths at the same time, it is to consider any beam associated with each light path and the obstacle height corresponding to the mesh at the same time, which is not elaborated here.

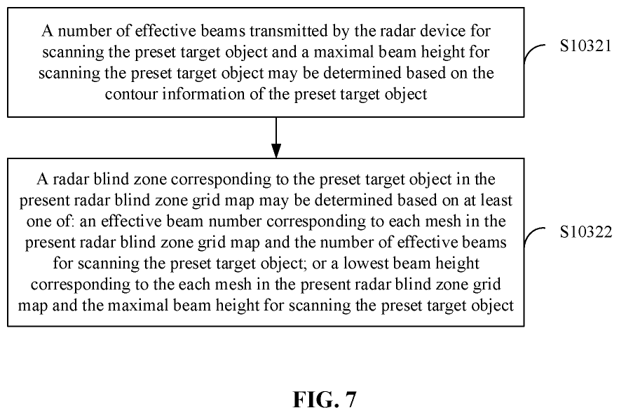

In S1032, as shown in FIG. 7, the radar blind zone information of the target vehicle for the preset target object may be determined based on the present radar blind zone grid map and the contour information of the preset target object via S10321˜S10322 as follows.

In S10321, a number of effective beams transmitted by the radar device for scanning the preset target object and a maximal beam height for scanning the preset target object may be determined based on the contour information of the preset target object.

Here, the contour information of the preset target object may also be indicated by information on the size of the 3D bounding frame corresponding to the preset target object. When scanning the preset target object corresponding to the 3D bounding frame by the radar, 3D bounding frames of different sizes have different effective beam numbers and different maximal beam heights. Here, a maximal beam height refers to a maximal beam height with which the preset target object can be scanned. In case the preset target object is scanned using a beam of a beam height less than or equal to the maximal beam height, the preset target object corresponding to the 3D bounding box may be scanned. In case the preset target object is scanned using a beam of a beam height greater than the maximal beam height, the preset target object cannot be scanned.

For example, after the contour information of the preset target object has been determined through the scene of application of the target vehicle, the number of effective beams of the radar device that do scan the preset target object and the lowest beam height corresponding to the effective beams may be determined.

In S10322, a radar blind zone corresponding to the preset target object in the present radar blind zone grid map may be determined based on an effective beam number corresponding to each mesh in the present radar blind zone grid map and the number of effective beams for scanning the preset target object. Alternatively, the radar blind zone corresponding to the preset target object in the present radar blind zone grid map may be determined based on a lowest beam height corresponding to the each mesh in the present radar blind zone grid map and the maximal beam height for scanning the preset target object. Alternatively, the radar blind zone corresponding to the preset target object in the present radar blind zone grid map may be determined based on the effective beam number corresponding to each mesh in the present radar blind zone grid map and the number of effective beams for scanning the preset target object, as well as the lowest beam height corresponding to the each mesh in the present radar blind zone grid map and the maximal beam height for scanning the preset target object.

For example, a mesh corresponding to an effective beam number less than the number of effective beams for scanning the preset target object may be taken as a radar blind zone corresponding to the preset target object in the present radar blind zone grid map. A mesh corresponding to a lowest beam height higher than the maximal beam height for scanning the preset target object may be taken as a radar blind zone corresponding to the preset target object in the present radar blind zone grid map. A mesh corresponding to an effective beam number less than the number of effective beams for scanning the preset target object, and a mesh corresponding to a lowest beam height higher than the maximal beam height for scanning the preset target object, may be taken as a radar blind zone corresponding to the preset target object in the present radar blind zone grid map.

In embodiments of the present disclosure, different radar blind zones may be determined for different preset target objects, facilitating timely update of radar blind zone information for different scenes of application, thereby effectively controlling the vehicle to avoid an obstacle.

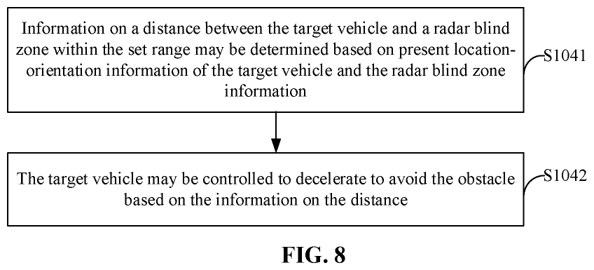

In S104, as shown in FIG. 8, the target vehicle may be controlled according to the radar blind zone information of the target vehicle via S1041˜S1042 as follows.

In S1041, information on a distance between the target vehicle and a radar blind zone within the set range may be determined based on present location-orientation information of the target vehicle and the radar blind zone information.

For example, the radar blind zone information includes a coordinate range corresponding to a boundary line of the radar blind zone in a vehicle coordinate system taking the target vehicle as the origin. The present location-orientation information of the target vehicle may include location information and orientation information of the target vehicle. Then, the information on the distance between the target vehicle and the radar blind zone within the set range may be determined based on the coordinate range corresponding to the radar blind zone. Here, the side of the target vehicle closest to the radar blind zone and the separation in between may be determined according to the orientation of the target vehicle.

In S1042, the target vehicle may be controlled, based on the information on the distance, to decelerate to avoid the obstacle.

In embodiments of the present disclosure, after the information on the distance has been acquired, it may be determined, based on the determined information on the distance, how the target vehicle is to travel so as to safely avoid the radar blind zone. For example, a change in the orientation and a change in the speed may be determined. In some embodiments, it may be determined based on a safe distance level to which the information on the distance belongs. The lower a safe distance level is, the closer the target vehicle is to the radar blind zone.

For example, if the information on the distance belongs to a low safe distance level, emergency brake may be applied at this time. If the information on the distance belongs to a high safe distance level, the vehicle may slow down along the original direction.

With embodiments of the present disclosure, obstacle avoidance may be performed based on present location-orientation information of the target vehicle and the radar blind zone information, thereby improving safety in travel of the target vehicle.

A person having ordinary skill in the art may understand that in a method of a specific implementation, the order in which the steps are put is not necessarily a strict order in which the steps are implemented, and does not form any limitation to the implementation process. A specific order in which the steps are implemented should be determined based on a function and a possible intrinsic logic of the steps.

Based on the same inventive concept, embodiments of the present disclosure further provide a device for controlling a vehicle corresponding to the method for controlling a vehicle. The device in embodiments of the present disclosure solves the problem with a principle similar to that applied by the method for controlling a vehicle in embodiments of the present disclosure. Refer to implementation of the method for implementation of the device, which is not repeated.

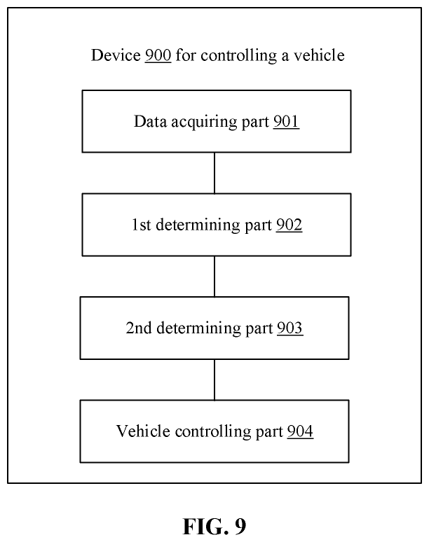

FIG. 9 is a diagram of a structure of a device 900 for controlling a vehicle according to an embodiment of the present disclosure. The device 900 for controlling a vehicle includes a data acquiring part 901, a first determining part 902, a second determining part 903, and a vehicle controlling part 904.

The data acquiring part 901 is configured to acquire point cloud data collected by a radar device on a target vehicle.

The first determining part 902 is configured to determine, based on the point cloud data, information on an obstacle within a set range from the target vehicle.

The second determining part 903 is configured to determine radar blind zone information of the target vehicle based on beam information of a beam transmitted by the radar device, as well as the information on the obstacle determined.

The vehicle controlling part 904 is configured to control the target vehicle according to the radar blind zone information of the target vehicle.

In possible implementation, the first determining part 902 is further configured to implement:

determining, based on the point cloud data, contour information of the obstacle within the set range from the target vehicle;

determining, based on contour information of each obstacle within the set range, an obstacle height of the each obstacle at a mesh in a pre-constructed grid map, the pre-constructed grid map being determined according to the shape and size of the target vehicle, the detection range of the radar on the target vehicle, and the grid resolution; and

acquiring, based on the obstacle height of the each obstacle at the mesh in the pre-constructed grid map, a present obstacle grid map representing the information on the obstacle within the set range from the target vehicle.

In possible implementation, the beam information includes a beam height of the beam transmitted by the radar device within the mesh in the pre-constructed grid map. The second determining part 903 may be further configured to implement:

determining a present radar blind zone grid map based on the beam height corresponding to the mesh in the pre-constructed grid map, as well as the present obstacle grid map; and

determining, based on the present radar blind zone grid map and contour information of a preset target object, radar blind zone information of the target vehicle for the preset target object.

In possible implementation, the second determining part 903 is further configured to implement:

acquiring an updated light path set by extracting a light path obstructed by any obstacle based on obstacle size information contained in the present obstacle grid map, as well as light path information acquired by projecting the beam transmitted by the radar device onto the present obstacle grid map;

determining, along a light path transmission direction of transmitting any light path in the updated light path set, a mesh index sequence corresponding to the any light path, the mesh index sequence representing indexes of meshes arranged along the light path transmission direction; and

acquiring the present radar blind zone grid map by performing adjustment on an effective beam number and a lowest beam height corresponding to each mesh indicated by the mesh index sequence according to a beam height of each beam associated with the any light path corresponding to the mesh index sequence at the each mesh indicated by the mesh index sequence and an obstacle height corresponding to the each mesh indicated by the mesh index sequence, until an effective beam number and a lowest beam height corresponding to each mesh in a last mesh index sequence have been adjusted.

In possible implementation, the second determining part 903 is further configured to implement:

successively comparing a beam height of the each beam corresponding to the mesh index sequence in a present mesh in the mesh index sequence to an obstacle height corresponding to the present mesh, and taking, as an effective beam corresponding to the present mesh, a beam corresponding to the mesh index sequence with a beam height in the present mesh higher than the obstacle height corresponding to the present mesh;

adjusting a lowest beam height corresponding to the present mesh based on the beam height of the effective beam corresponding to the present mesh; adjusting an effective beam number corresponding to the present mesh based on a number of effective beams corresponding to the present mesh of any beam corresponding to the mesh index sequence; and

acquiring the effective beam number and the lowest beam height corresponding to the each mesh indicated by the mesh index sequence after the adjustment by taking the effective beam corresponding to the present mesh as a beam entering a next mesh in the mesh index sequence, taking the next mesh as the present mesh, and continuing to adjust the effective beam number and the lowest beam height corresponding to the present mesh, until the beam height of the each beam entering the present mesh is lower than the obstacle height corresponding to the present mesh.

In possible implementation, the second determining part 903 is further configured to implement:

determining, based on the contour information of the preset target object, a number of effective beams transmitted by the radar device for scanning the preset target object and a maximal beam height for scanning the preset target object; and

determining a radar blind zone corresponding to the preset target object in the present radar blind zone grid map based on at least one of: an effective beam number corresponding to each mesh in the present radar blind zone grid map and the number of effective beams for scanning the preset target object; or a lowest beam height corresponding to the each mesh in the present radar blind zone grid map and the maximal beam height for scanning the preset target object.

In possible implementation, the vehicle controlling part 904 is further configured to implement:

determining information on a distance between the target vehicle and a radar blind zone within the set range based on present location-orientation information of the target vehicle and the radar blind zone information; and

controlling the target vehicle to decelerate to avoid the obstacle based on the information on the distance.

In embodiments of the present disclosure and other embodiments, a “part” may be a part of a circuit, a part of a processor, a part of a program or software, etc. Of course, a part may be a unit or a module, or may be non-modularized.

Refer to associated description in an aforementioned method embodiment for description of processing by a module in the device, as well as inter-module interaction, which is not elaborated here.

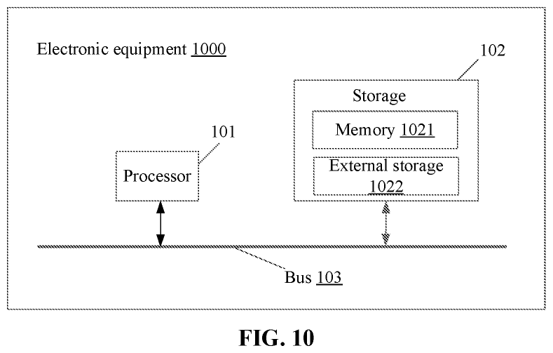

Embodiments of the present disclosure further provide electronic equipment 1000 corresponding to the method for controlling a vehicle in FIG. 1. FIG. 10 is a diagram of a structure of electronic equipment 1000 according to an embodiment of the present disclosure.

The electronic equipment includes a processor 101, a storage 102, and a bus 103. The storage 102 is configured to store executable instructions, and includes a memory 1021 and an external storage 1022. Here, the memory 1021 is also referred to as an internal storage, and is configured to temporarily store operation data in the processor 101 and data exchanged with the external storage 1022 such as a hard disk. The processor 101 exchanges data with the external storage 1022 through the memory 1021. In case the electronic equipment 1000 operates, the processor 101 communicates with the storage 102 through the bus 103, so that the processor 101 executes instructions for: while a target vehicle travels, acquiring point cloud data collected by a radar device; determining, based on the point cloud data, information on an obstacle within a set range from the target vehicle; determining radar blind zone information of the target vehicle based on beam information of a beam transmitted by the radar device, as well as the information on the obstacle determined; and controlling the target vehicle according to the radar blind zone information of the target vehicle.

Embodiments of the present disclosure further provide a computer-readable storage medium, having stored thereon a computer program which, when executed by a processor, implements the steps of a method for controlling a vehicle according to an aforementioned method embodiment. The storage medium may be a volatile or non-volatile computer-readable storage medium.

A computer program product of a method for controlling a vehicle according to embodiments of the present disclosure includes a computer-readable storage medium storing a program code. Instructions included in the program code may be configured to implement the steps of a method for controlling a vehicle according to an aforementioned method embodiment. Refer to an aforementioned method embodiment for details, which are not repeated here.

Embodiments of the present disclosure further provide a computer program which, when executed by a processor, implements any method of a foregoing embodiment. The computer program product may be implemented in particular through hardware, software, or a combination of hardware and software. In an optional embodiment, the computer program product is embodied as a computer storage medium. In another optional embodiment, the computer program product is embodied as a software product, such as a Software Development Kit (SDK), etc.

A person having ordinary skill in the art will clearly understand that, for convenience and conciseness of description, reference may be made to a corresponding process in a foregoing method embodiment for a detailed working process of the system and device described above, which is not repeated here. In the several embodiments provided by the present disclosure, it should be understood that the disclosed systems, devices, and methods may be implemented in other modes. A device embodiment described herein is but illustrative. For example, the division of modules is merely division of logic functions, and there may be another mode of division in actual implementation. As another example, a plurality of units or components may be combined or integrated into another system, or some features may be ignored or not implemented. Furthermore, the inter-coupling, or direct coupling or communicational connection illustrated or discussed may be communicational connection or indirect coupling through some communication interfaces, devices, or units, and may be electrical, mechanical, or of another form.

The units described as separate components may or may not be physically separated. Components shown as units may be or may not be physical units. They may be located in one place, or distributed on multiple network units. Some or all of the units may be selected to achieve the purpose of a solution of the present embodiments as needed.

In addition, functional units in embodiments of the present disclosure may be integrated in one processing part, or exist as separate physical units respectively. Alternatively, two or more units may be integrated in one unit.

When implemented in form of a software functional unit and sold or used as an independent product, the function may be stored in a transitory or non-transitory computer-readable storage medium executable by a processor. Based on such an understanding, the essential part or a part contributing to prior art of the technical solution of the present disclosure or part of the technical solution may appear in form of a software product. The software product is stored in a storage medium, and includes a number of instructions for allowing computer equipment (such as a personal computer, a server, network equipment, etc.) to execute all or part of a method in an embodiment of the present disclosure. The storage medium includes various media that may store program codes, such as a U disk, a mobile hard disk, Read-Only Memory (ROM), Random Access Memory (RAM), a magnetic disk, a CD, etc.

Finally, it should be noted that the embodiments are just specific implementations of the present disclosure for describing a technical solution of the present disclosure, instead of limiting the present disclosure. The scope of the present disclosure is not limited thereto. The present disclosure is elaborated with the embodiments. A person having ordinary skill in the art shall understand that within the technical scope disclosed in the present disclosure, any person familiar with the art may modify a technical solution according to the embodiments or may think of a change easily, or perform an equivalent replacement to some technical characteristics of the technical solution, without essentially departing from the spirit and scope of the technical solution of embodiments of the present disclosure. Any such modification, change, or replacement should be covered by the scope of the present disclosure. The scope of the present disclosure thus should be determined by the claims.

In embodiments of the present disclosure, in the travel process of the target vehicle, the radar blind zone information may be determined based on the information on the obstacle within the set range from the target vehicle as well as the beam information of the beam transmitted by the radar device. In this way, in the travel process of the target vehicle, the radar blind zone information for the target vehicle in the travel process may be determined constantly through the changing information on the obstacle. Accordingly, the travel process of the target vehicle may be controlled effectively based on this, thereby reducing probability of occurrence of collision to the target vehicle, improving safety.

What is claimed is:

1. A method for controlling a vehicle, comprising:
acquiring point cloud data collected by a radar device on a target vehicle;
determining, based on the point cloud data, information on an obstacle within a set range from the target vehicle;
determining radar blind zone information of the target vehicle based on beam information of a beam transmitted by the radar device, as well as the information on the obstacle determined; and
controlling the target vehicle according to the radar blind zone information of the target vehicle.

2. The method of claim 1, wherein determining, based on the point cloud data, the information on the obstacle within the set range from the target vehicle comprises:
determining, based on the point cloud data, contour information of the obstacle within the set range from the target vehicle;
determining, based on contour information of each obstacle within the set range, an obstacle height of the each obstacle at a mesh in a pre-constructed grid map; and
acquiring, based on the obstacle height of the each obstacle at the mesh in the pre-constructed grid map, a present obstacle grid map representing the information on the obstacle within the set range from the target vehicle.

3. The method of claim 2, wherein the beam information comprises a beam height of the beam transmitted by the radar device within the mesh in the pre-constructed grid map, wherein determining the radar blind zone information of the target vehicle based on the beam information of the beam transmitted by the radar device, as well as the information on the obstacle determined, comprises:
determining a present radar blind zone grid map based on the beam height corresponding to the mesh in the pre-constructed grid map, as well as the present obstacle grid map; and
determining, based on the present radar blind zone grid map and contour information of a preset target object, radar blind zone information of the target vehicle for the preset target object.

4. The method of claim 3, wherein determining the present radar blind zone grid map based on the beam height corresponding to the mesh in the pre-constructed grid map, as well as the present obstacle grid map, comprises:
acquiring an updated light path set by extracting a light path obstructed by any obstacle based on obstacle size information contained in the present obstacle grid map, as well as light path information acquired by projecting the beam transmitted by the radar device onto the present obstacle grid map;
determining, along a light path transmission direction of transmitting any light path in the updated light path set, a mesh index sequence corresponding to the any light path, the mesh index sequence representing indexes of meshes arranged along the light path transmission direction; and
acquiring the present radar blind zone grid map by performing adjustment on an effective beam number and a lowest beam height corresponding to each mesh indicated by the mesh index sequence according to a beam height of each beam associated with the any light path corresponding to the mesh index sequence at the each mesh indicated by the mesh index sequence and an obstacle height corresponding to the each mesh indicated by the mesh index sequence, until an effective beam number and a lowest beam height corresponding to each mesh in a last mesh index sequence have been adjusted.

5. The method of claim 4, wherein performing the adjustment on the effective beam number and the lowest beam height corresponding to the each mesh indicated by the mesh index sequence comprises:
successively comparing a beam height of the each beam corresponding to the mesh index sequence in a present mesh in the mesh index sequence to an obstacle height corresponding to the present mesh, and taking, as an effective beam corresponding to the present mesh, a beam corresponding to the mesh index sequence with a beam height in the present mesh higher than the obstacle height corresponding to the present mesh;
adjusting a lowest beam height corresponding to the present mesh based on the beam height of the effective beam corresponding to the present mesh; adjusting an effective beam number corresponding to the present mesh based on a number of effective beams corresponding to the present mesh of any beam corresponding to the mesh index sequence; and
acquiring the effective beam number and the lowest beam height corresponding to the each mesh indicated by the mesh index sequence after the adjustment by taking the effective beam corresponding to the present mesh as a beam entering a next mesh in the mesh index sequence, taking the next mesh as the present mesh, and continuing to adjust the effective beam number and the lowest beam height corresponding to the present mesh, until the beam height of the each beam entering the present mesh is lower than the obstacle height corresponding to the present mesh.

6. The method of claim 3, wherein determining, based on the present radar blind zone grid map and the contour information of the preset target object, the radar blind zone information of the target vehicle for the preset target object comprises:
determining, based on the contour information of the preset target object, a number of effective beams transmitted by the radar device for scanning the preset target object and a maximal beam height for scanning the preset target object; and
determining a radar blind zone corresponding to the preset target object in the present radar blind zone grid map based on at least one of: an effective beam number corresponding to each mesh in the present radar blind zone grid map and the number of effective beams for scanning the preset target object; or a lowest beam height corresponding to the each mesh in the present radar blind zone grid map and the maximal beam height for scanning the preset target object.

7. The method of claim 1, wherein controlling the target vehicle according to the radar blind zone information of the target vehicle comprises:
determining information on a distance between the target vehicle and a radar blind zone within the set range based on present location-orientation information of the target vehicle and the radar blind zone information; and
controlling the target vehicle to decelerate to avoid the obstacle based on the information on the distance.

8. Electronic equipment, comprising a processor, a storage, and a bus, the storage storing machine-readable instructions executable by the processor, the processor and the storage communicating via the bus when the electronic equipment operates, wherein when executed by the processor, the machine-readable instructions implement:
acquiring point cloud data collected by a radar device on a target vehicle;
determining, based on the point cloud data, information on an obstacle within a set range from the target vehicle;
determining radar blind zone information of the target vehicle based on beam information of a beam transmitted by the radar device, as well as the information on the obstacle determined; and
controlling the target vehicle according to the radar blind zone information of the target vehicle.

9. The electronic equipment of claim 8, wherein the processor is configured to determine, based on the point cloud data, the information on the obstacle within the set range from the target vehicle, by:
determining, based on the point cloud data, contour information of the obstacle within the set range from the target vehicle;
determining, based on contour information of each obstacle within the set range, an obstacle height of the each obstacle at a mesh in a pre-constructed grid map; and
acquiring, based on the obstacle height of the each obstacle at the mesh in the pre-constructed grid map, a present obstacle grid map representing the information on the obstacle within the set range from the target vehicle.

10. The electronic equipment of claim 9, wherein the beam information comprises a beam height of the beam transmitted by the radar device within the mesh in the pre-constructed grid map, wherein the processor is configured to determine the radar blind zone information of the target vehicle based on the beam information of the beam transmitted by the radar device, as well as the information on the obstacle determined, by:
determining a present radar blind zone grid map based on the beam height corresponding to the mesh in the pre-constructed grid map, as well as the present obstacle grid map; and
determining, based on the present radar blind zone grid map and contour information of a preset target object, radar blind zone information of the target vehicle for the preset target object.

11. The electronic equipment of claim 10, wherein the processor is configured to determine the present radar blind zone grid map based on the beam height corresponding to the mesh in the pre-constructed grid map, as well as the present obstacle grid map, by:
acquiring an updated light path set by extracting a light path obstructed by any obstacle based on obstacle size information contained in the present obstacle grid map, as well as light path information acquired by projecting the beam transmitted by the radar device onto the present obstacle grid map;
determining, along a light path transmission direction of transmitting any light path in the updated light path set, a mesh index sequence corresponding to the any light path, the mesh index sequence representing indexes of meshes arranged along the light path transmission direction; and
acquiring the present radar blind zone grid map by performing adjustment on an effective beam number and a lowest beam height corresponding to each mesh indicated by the mesh index sequence according to a beam height of each beam associated with the any light path corresponding to the mesh index sequence at the each mesh indicated by the mesh index sequence and an obstacle height corresponding to the each mesh indicated by the mesh index sequence, until an effective beam number and a lowest beam height corresponding to each mesh in a last mesh index sequence have been adjusted.

12. The electronic equipment of claim 11, wherein the processor is configured to perform the adjustment on the effective beam number and the lowest beam height corresponding to the each mesh indicated by the mesh index sequence, by:
successively comparing a beam height of the each beam corresponding to the mesh index sequence in a present mesh in the mesh index sequence to an obstacle height corresponding to the present mesh, and taking, as an effective beam corresponding to the present mesh, a beam corresponding to the mesh index sequence with a beam height in the present mesh higher than the obstacle height corresponding to the present mesh;
adjusting a lowest beam height corresponding to the present mesh based on the beam height of the effective beam corresponding to the present mesh; adjusting an effective beam number corresponding to the present mesh based on a number of effective beams corresponding to the present mesh of any beam corresponding to the mesh index sequence; and
acquiring the effective beam number and the lowest beam height corresponding to the each mesh indicated by the mesh index sequence after the adjustment by taking the effective beam corresponding to the present mesh as a beam entering a next mesh in the mesh index sequence, taking the next mesh as the present mesh, and continuing to adjust the effective beam number and the lowest beam height corresponding to the present mesh, until the beam height of the each beam entering the present mesh is lower than the obstacle height corresponding to the present mesh.

13. The electronic equipment of claim 10, wherein the processor is configured to determine, based on the present radar blind zone grid map and the contour information of the preset target object, the radar blind zone information of the target vehicle for the preset target object, by:
determining, based on the contour information of the preset target object, a number of effective beams transmitted by the radar device for scanning the preset target object and a maximal beam height for scanning the preset target object; and
determining a radar blind zone corresponding to the preset target object in the present radar blind zone grid map based on at least one of: an effective beam number corresponding to each mesh in the present radar blind zone grid map and the number of effective beams for scanning the preset target object; or a lowest beam height corresponding to the each mesh in the present radar blind zone grid map and the maximal beam height for scanning the preset target object.

14. The electronic equipment of claim 8, wherein the processor is configured to control the target vehicle according to the radar blind zone information of the target vehicle by:
determining information on a distance between the target vehicle and a radar blind zone within the set range based on present location-orientation information of the target vehicle and the radar blind zone information; and
controlling the target vehicle to decelerate to avoid the obstacle based on the information on the distance.

15. A non-transitory computer-readable storage medium, having stored thereon a computer program which, when executed by a processor, implements:
acquiring point cloud data collected by a radar device on a target vehicle;
determining, based on the point cloud data, information on an obstacle within a set range from the target vehicle;
determining radar blind zone information of the target vehicle based on beam information of a beam transmitted by the radar device, as well as the information on the obstacle determined; and
controlling the target vehicle according to the radar blind zone information of the target vehicle.

16. The storage medium of claim 15, wherein determining, based on the point cloud data, the information on the obstacle within the set range from the target vehicle comprises:
determining, based on the point cloud data, contour information of the obstacle within the set range from the target vehicle;
determining, based on contour information of each obstacle within the set range, an obstacle height of the each obstacle at a mesh in a pre-constructed grid map; and
acquiring, based on the obstacle height of the each obstacle at the mesh in the pre-constructed grid map, a present obstacle grid map representing the information on the obstacle within the set range from the target vehicle.

17. The storage medium of claim 16, wherein the beam information comprises a beam height of the beam transmitted by the radar device within the mesh in the pre-constructed grid map, wherein determining the radar blind zone information of the target vehicle based on the beam information of the beam transmitted by the radar device, as well as the information on the obstacle determined, comprises:
determining a present radar blind zone grid map based on the beam height corresponding to the mesh in the pre-constructed grid map, as well as the present obstacle grid map; and
determining, based on the present radar blind zone grid map and contour information of a preset target object, radar blind zone information of the target vehicle for the preset target object.

18. The storage medium of claim 17, wherein determining the present radar blind zone grid map based on the beam height corresponding to the mesh in the pre-constructed grid map, as well as the present obstacle grid map, comprises:
acquiring an updated light path set by extracting a light path obstructed by any obstacle based on obstacle size information contained in the present obstacle grid map, as well as light path information acquired by projecting the beam transmitted by the radar device onto the present obstacle grid map;
determining, along a light path transmission direction of transmitting any light path in the updated light path set, a mesh index sequence corresponding to the any light path, the mesh index sequence representing indexes of meshes arranged along the light path transmission direction; and
acquiring the present radar blind zone grid map by performing adjustment on an effective beam number and a lowest beam height corresponding to each mesh indicated by the mesh index sequence according to a beam height of each beam associated with the any light path corresponding to the mesh index sequence at the each mesh indicated by the mesh index sequence and an obstacle height corresponding to the each mesh indicated by the mesh index sequence, until an effective beam number and a lowest beam height corresponding to each mesh in a last mesh index sequence have been adjusted.

19. The storage medium of claim 17, wherein determining, based on the present radar blind zone grid map and the contour information of the preset target object, the radar blind zone information of the target vehicle for the preset target object comprises:
determining, based on the contour information of the preset target object, a number of effective beams transmitted by the radar device for scanning the preset target object and a maximal beam height for scanning the preset target object; and
determining a radar blind zone corresponding to the preset target object in the present radar blind zone grid map based on at least one of: an effective beam number corresponding to each mesh in the present radar blind zone grid map and the number of effective beams for scanning the preset target object; or a lowest beam height corresponding to the each mesh in the present radar blind zone grid map and the maximal beam height for scanning the preset target object.

20. The storage medium of claim 15, wherein controlling the target vehicle according to the radar blind zone information of the target vehicle comprises:
determining information on a distance between the target vehicle and a radar blind zone within the set range based on present location-orientation information of the target vehicle and the radar blind zone information; and
controlling the target vehicle to decelerate to avoid the obstacle based on the information on the distance.
